(19) United States
(12) Patent Application Publication
(10) Pub. No.: US 2012/0115496 A1
(43) Pub. Date: May 10, 2012

(54) SYSTEM AND METHOD FOR SYNCHRONIZING FEMTOCELLS USING INTERCELL UPLINK SIGNALS

(75) Inventors: Samir S. Soliman, San Diego, CA (US); Olufunmilola O. Awoniyi, San Diego, CA (US)

(73) Assignee: QUALCOMM Incorporated, San Diego, CA (US)

(21) Appl. No.: 12/940,583

(22) Filed: Nov. 5, 2010

(51) Int. Cl. H04W 72/04

(52) U.S. Cl. 455/452.1; 455/450

(57) ABSTRACT

A system and method provides accurate and timely updates to timing and/or frequency information for a femtocell utilizing information gathered from user equipment camped on a neighboring macrocell. In one example, user equipment camped on the neighboring macrocell actively gathers aiding information such as timing and frequency information related to the macrocell on which it is camped. The user equipment then transmits the aiding information to the femtocell utilizing a different link other than that used for communicating with the macrocell. In another example, the femtocell sniffs uplink transmissions from the user equipment that are not directed at the femtocell, but rather are normal communications between the user equipment and its serving macrocell. Here, the femtocell utilizes information it gathers about the macrocell and utilizes its WWAN interface to sniff the uplink transmissions from the user equipment and extracts timing and/or frequency information based on those transmissions.

### BACKGROUND

1. Field

The present application relates generally to wireless communications, and more specifically to methods and systems for synchronizing a femtocell unit to a macrocell in a wireless communication network using intercell uplink signals.

2. Background

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

In recent years, users have started to replace fixed line broadband communications with mobile broadband communications and have increasingly demanded great voice quality, reliable service, and low prices, especially at their home or office locations. In order to provide indoor services, network operators may deploy different solutions. For networks with moderate traffic, operators may rely on macrocellular base stations to transmit the signal into buildings. However, in areas where building penetration loss is high, it may be difficult to maintain acceptable signal quality, and thus other solutions are desired. New solutions are frequently desired to make the best of the limited radio resources such as space and spectrum. Some of these solutions include intelligent repeaters, remote radio heads, picocells, and femtocells.

The Femto Forum, a non-profit membership organization focused on standardization and promotion of femtocell solutions, defines femtocells to be low-powered wireless access points that operate in licensed spectrum and are controlled by the network operator, can be connected with existing handsets, and use a residential DSL or cable connection for backhaul. In various standards or contexts, a femtocell may be referred to as a femto access point (FAP), home node B (HNB), home e-node B (HeNB), access point base station, etc.

In essence, femtocells are very small, low-cost base stations having a relatively low maximum allowed transmit power. For example, a femtocell may be integrated into a small plastic desktop or wall mount case and installed by the user. The user's existing DSL or cable connections may be used as backhaul connections. With this topology, femtocells can be used in rural area as well as in dense urban areas.

In order to keep the expenses low, it is desired for femtocells to require very little for installation and setup. This means that femtocells may be auto-configuring such that the user only needs to plug in the cables for the internet connection and electricity, and everything else is taken care of automatically.

### SUMMARY

A system and method provides accurate and timely updates to timing and/or frequency information for a femtocell utilizing information gathered from user equipment camped on a neighboring macrocell. In one example, user equipment camped on the neighboring macrocell actively gathers aiding information such as timing and frequency information related to the macrocell on which it is camped. The user equipment then transmits the aiding information to the femtocell utilizing a different link from the one used to communicate with the macrocell. In another example, the femtocell sniffs uplink transmissions from the user equipment that are not directed at the femtocell, but rather are normal communications between the user equipment and its serving macrocell. Here, the femtocell utilizes information it gathers about the macrocell and utilizes its WWAN interface to sniff the uplink transmissions from the user equipment and extracts timing and/or frequency information based on those transmissions.

In accordance with an exemplary aspect of the disclosure, a method of wireless communication includes establishing a communication link with a macrocell and transmitting first aiding information corresponding to the macrocell to a femtocell while maintaining the communication link with the macrocell. In another aspect of the disclosure, an apparatus for wireless communication includes at least one processor and a memory coupled to the at least one processor, wherein the at least one processor is configured to establish a communication link with a macrocell and transmit first aiding information corresponding to the macrocell to a femtocell while maintaining the communication link with the macrocell. In yet another aspect of the disclosure, an apparatus for wireless communication includes means for establishing a communication link with a macrocell, and means for transmitting first aiding information corresponding to the macrocell to a femtocell while maintaining the communication link with the macrocell. In still another aspect of the disclosure, a computer program product for use in a wireless communication network comprising a plurality of cells includes a computer-readable medium having code for establishing a communication link with a macrocell, and transmitting first aiding information corresponding to the macrocell to a femtocell while maintaining the communication link with the macrocell.

In accordance with another exemplary aspect of the disclosure, a method of wireless communication in a network having a plurality of cells includes receiving at a femtocell first aiding information from a first UE, the first aiding information corresponding to at least one cell of the plurality of cells, and adjusting a reference timing and/or frequency of the femtocell in response to the first aiding information. In another aspect of the disclosure an apparatus for wireless communication in a network having a plurality of cells includes at least one processor and a memory coupled to the at least one processor, wherein the at least one processor is configured to receive at a femtocell first aiding information from a first UE, the first aiding information corresponding to at least one cell of the plurality of cells and adjust a reference timing and/or frequency of the femtocell in response to the first aiding information. In yet another aspect of the disclosure, an apparatus for wireless communication in a network having a plurality of cells includes means for receiving at a femtocell first aiding information from a first UE, the first aiding information corresponding to at least one cell of the plurality of cells and means for adjusting a reference timing and/or frequency of the femtocell in response to the first aiding information. In still another aspect of the disclosure, a computer program product for use in a wireless communication network having a plurality of cells includes a computer-readable medium having code for receiving at a femtocell first aiding information from a first UE, the first aiding information corresponding to at least one cell of the plurality of cells, and adjusting a reference timing and/or frequency of the femtocell in response to the first aiding information.

In accordance with yet another exemplary aspect of the disclosure, a method of wireless communication includes sniffing an uplink transmission from a first UE connected to a neighboring cell, and determining aiding information corresponding to the neighboring cell based on the uplink transmission from the first UE. In another aspect of the disclosure, an apparatus for wireless communication includes at least one processor and a memory coupled to the at least one processor, wherein the at least one processor is configured to sniff an uplink transmission from a first UE connected to a neighboring cell and determine aiding information corresponding to the neighboring cell based on the uplink transmission from the first UE. In yet another aspect of the disclosure, an apparatus for wireless communication includes means for sniffing an uplink transmission from a first UE camped on a neighboring cell and means for determining aiding information corresponding to the neighboring cell based on the uplink transmission from the first UE. In still another aspect of the disclosure, a computer program product for use in a wireless communication network comprising a plurality of cells includes a computer-readable medium having code for sniffing an uplink transmission from a first UE camped on a neighboring cell, and determining aiding information corresponding to the neighboring cell based on the uplink transmission from the first UE.

These and other aspects of the disclosure will become readily apparent to one of ordinary skill in the art upon a review of the detailed description, which follows.

### BRIEF DESCRIPTION OF THE DRAWINGS

FIG. 1 is a conceptual diagram illustrating an example of a hardware implementation for an apparatus employing a processing system.

FIG. 2 illustrates an exemplary wireless communication system.

FIG. 3 illustrates an exemplary communication system to enable deployment of Home Node Bs (HNBs) within a network environment.

FIG. 4A-4B are a block diagrams illustrating a femtocell unit and a user equipment according to an aspect of the disclosure.

FIG. 4C is a flow chart illustrating a process for providing aiding information to a femtocell in accordance with an aspect of the disclosure.

FIG. 5 is a conceptual diagram illustrating the utilization of interference from MUEs by a neighboring femtocell according to an aspect of the disclosure.

FIG. 6 is a timing diagram illustrating timing relationships between transmissions on the P-CCPCH and AICH channels.

FIG. 7 is a timing diagram illustrating timing relationships between transmissions on the PRACH and AICH channels.

FIG. 8 is a timing diagram illustrating timing relationships between the PRACH, AICH, F-DPCH, and DPCCH transmissions.

FIG. 9 is a timing diagram illustrating a timing relationship at the UE between the F-DPCH and the UL DPCCH transmissions.

FIG. 10 is a conceptual diagram illustrating the generation of a preamble signal.

FIG. 11 is a conceptual diagram illustrating PRACH physical layer processing.

FIG. 12 is a conceptual diagram illustrating UL DPCCH and UL DPDCH physical layer processing.

FIGS. 13A and 13B are timing diagrams illustrating timing relationships between UL DPCCH, P-CCPCH and DPCH or F-DPCH transmissions.

FIG. 14 is a timing diagram illustrating the determination of the slot timing of the P-CCPCH using the PRACH preamble and PRACH message part in the CELL_FACH state in accordance with an aspect of the disclosure.

FIG. 15 is a timing diagram illustrating the determination of the slot timing of the P-CCPCH using the PRACH message part in the CELL_FACH state in accordance with an aspect of the disclosure.

FIG. 16 is a timing diagram illustrating the determination of the slot timing of the P-CCPCH using the UL DPCCH in the CELL_FACH state in accordance with an aspect of the disclosure.

FIG. 17 is a timing diagram illustrating the determination of the slot and frame timing of the P-CCPCH using the UL DPCCH in the CELL_DCH state in accordance with an aspect of the disclosure.

FIGS. 18A and 18B are flow charts illustrating a process for determining the slot timing of the P-CCPCH as shown in the timing diagrams of FIGS. 14-17 in accordance with an aspect of the disclosure.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The techniques described herein may be used for various wireless communication networks such as Code Division Multiple Access (CDMA) networks, Time Division Multiple Access (TDMA) networks, Frequency Division Multiple Access (FDMA) networks, Orthogonal Frequency Division Multiplexing (OFDM) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR) TD-SCDMA. cdma2000 covers IS-2000, IS-95 and IS-856 standards. A TDMA network may implement a radio technology such as Global System for Mobile Communications (GSM). An OFDM network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an advanced release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

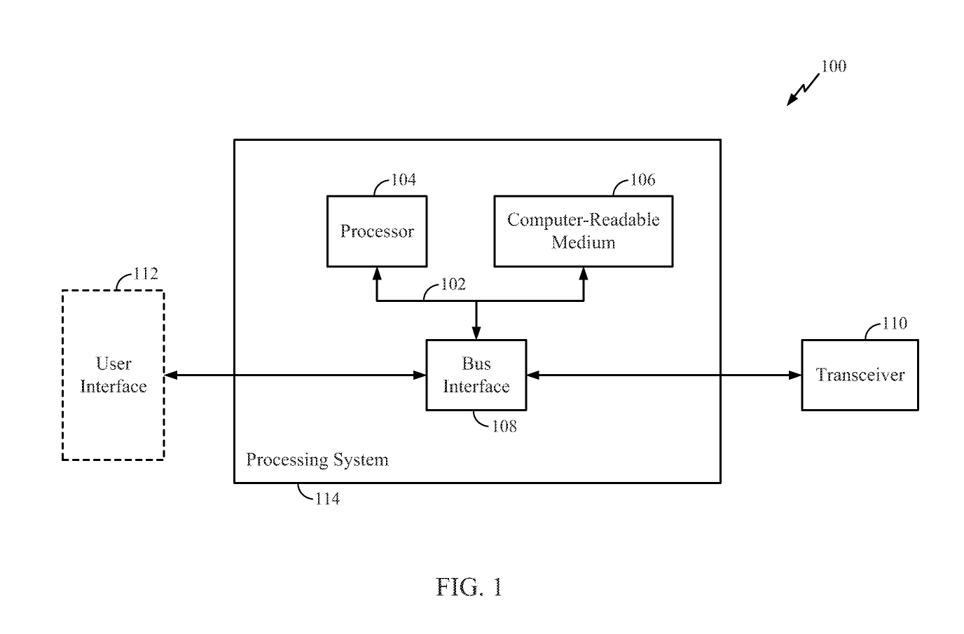

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

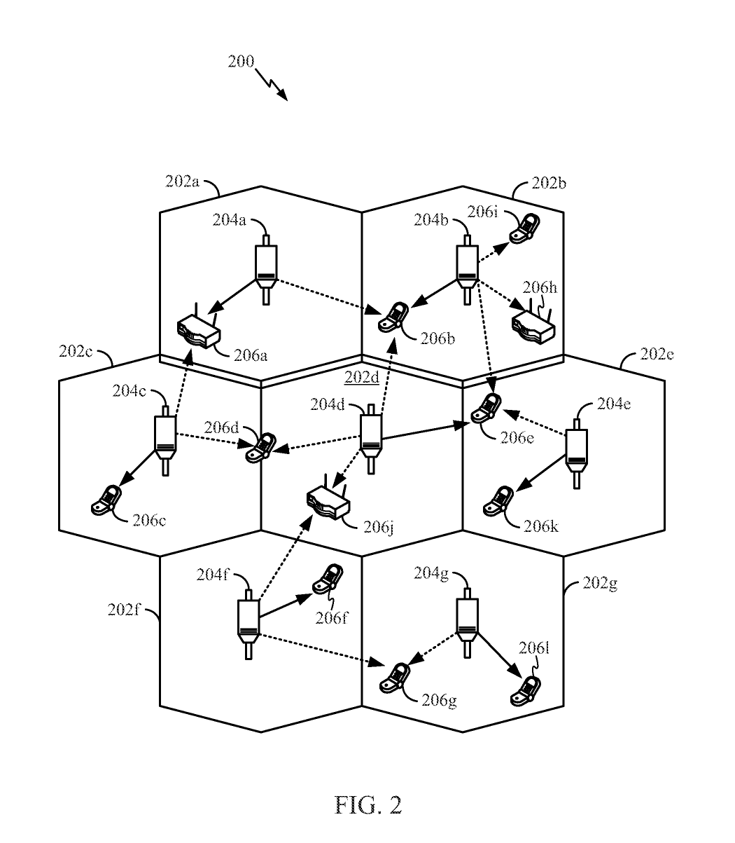

FIG. 2 illustrates an exemplary wireless communication system 200 configured to support a number of users, in which various disclosed embodiments and aspects may be implemented. As shown in FIG. 2, by way of example, system 200 provides communication for multiple cells 202, such as, for example, macrocells 202a-202g, with each macrocell 202 being serviced by a corresponding base station 204 (such as base stations 204a-204g), also known variously as Node Bs (NBs), eNode Bs (eNBs), etc. Each macrocell 202 may be further divided into two or more sectors. Each of the base stations 204 may be suitably coupled to a core network (not illustrated), enabling information to be passed between the various base stations 204 and, in some examples, to the Internet. Various mobile stations 206, including mobile stations 206a-206k, also known variously as access terminals (AT), user equipment (UE) etc., are dispersed throughout the system. Each mobile station 206 may communicate with one or more base stations 204 on a downlink (DL) and/or an uplink (UL) at a given moment, depending upon whether the base station 206 is active and whether it is in soft handoff, for example. The wireless communication system 200 may provide service over a large geographic region; for example, macrocells 202 may cover a few blocks in a neighborhood. In another example, the macrocells 202 may be augmented by, or one or more of the macrocells may be replaced by, smaller cells (i.e., having a smaller geographic service area) such as so-called microcells or picocells. As discussed below, the wireless communication system 200 may be further augmented by femtocells with even smaller and more specific geographic coverage areas.

In general, when a mobile station 206 is switched on, a public land mobile network (PLMN) is selected and the mobile station 206 searches for a suitable cell of this PLMN to camp on. Criteria for cell selection and cell re-selection between radio access technologies (RATs) generally depend on various radio criteria. In addition to the RAT, the PLMN type may differ as well. The mobile station 206 searches for a suitable cell of the selected PLMN and chooses that cell to provide available services, and tunes to its control channel. This choosing is known as “camping on the cell”. The mobile station 206 will, if necessary, then register its presence in the registration area of the chosen cell and as the outcome of a successful Location Registration the selected PLMN becomes the registered PLMN.

If the mobile station 206 finds a more suitable cell, it reselects onto that cell and camps on it. If the new cell is in a different registration area, location registration is performed. If necessary, the mobile station 206 may search for higher priority PLMNs at regular time intervals and search for a suitable cell if another PLMN has been selected.

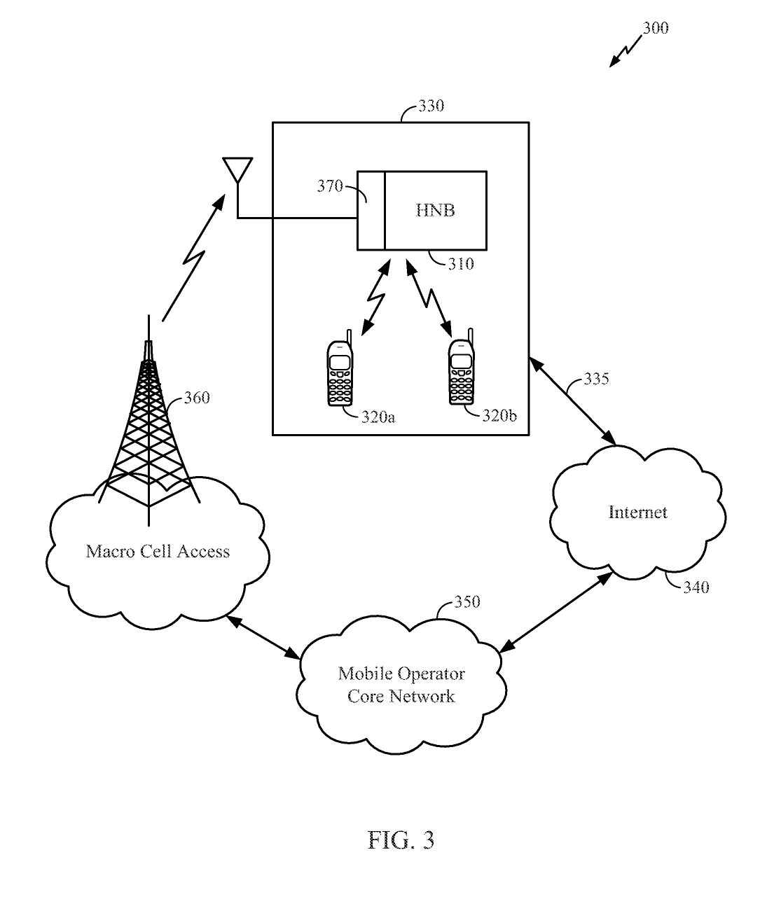

FIG. 3 illustrates an exemplary communication system to enable deployment of femtocells within a network environment. As shown in FIG. 3, the system 300 includes a femtocell unit 310 installed in a corresponding small scale network environment, such as, for example, in one or more user residences 330, and being configured to serve associated, as well as alien, mobile stations 320a and 320b. The femtocell unit 310 may be coupled to the Internet 340 by way of a backhaul connection 335, for example, a cable or DSL connection. The femtocell unit 310 is further communicatively coupled to a mobile operator core network 350 via the Internet 340 utilizing suitable communication hardware and software. Further, the femtocell unit 310 may be communicatively coupled to one or more macrocell base stations 360 utilizing a network listen component 370 for sniffing the air interface broadcasted by one or more of the macrocell base stations 360. This functionality is discussed below in further detail.

Although some of the embodiments described hereinbelow use 3GPP terminology, it is to be understood that the embodiments may be applied to 3GPP technology, as well as 3GPP2 technology and other known and related technologies. In such embodiments described herein, the owner of the femtocell unit 310 subscribes to a mobile service, such as, for example, 3G mobile service from a provider of HSPA, offered through the mobile operator core network 350, and the mobile station, e.g., the UE 320, is capable to operate both in macrocellular environment and in a residential small scale network environment. Thus, the femtocell unit 310 may be backward compatible with any existing UE 320.

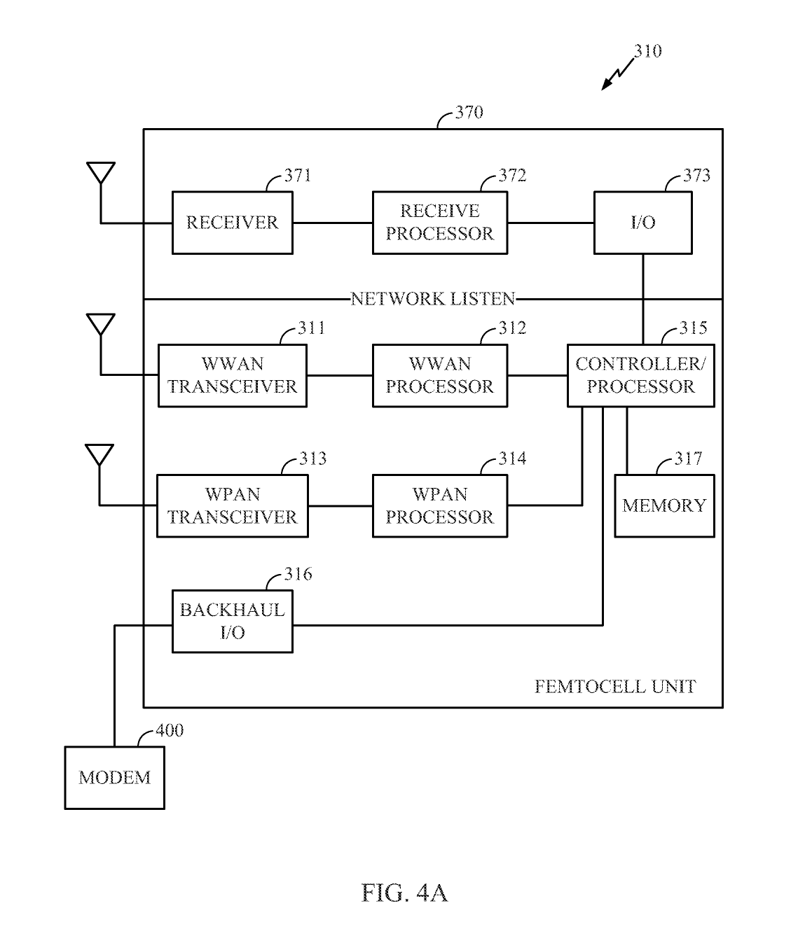

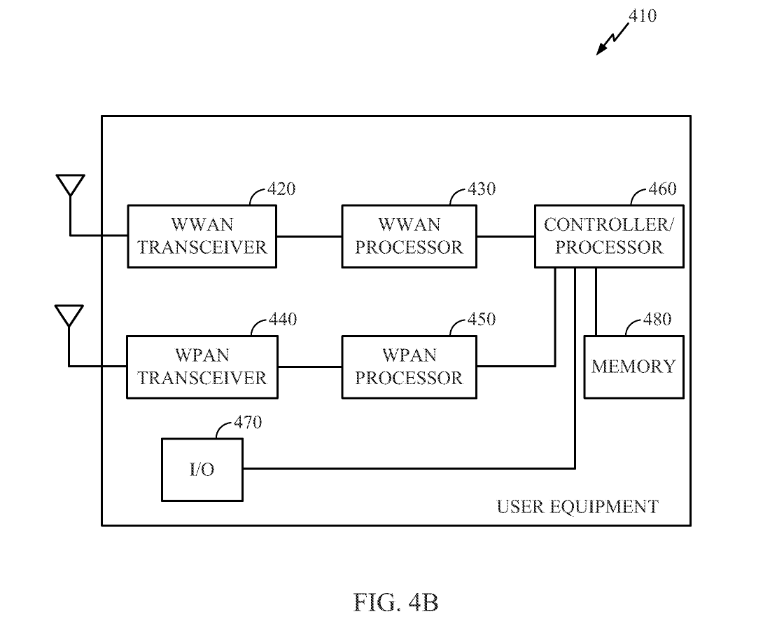

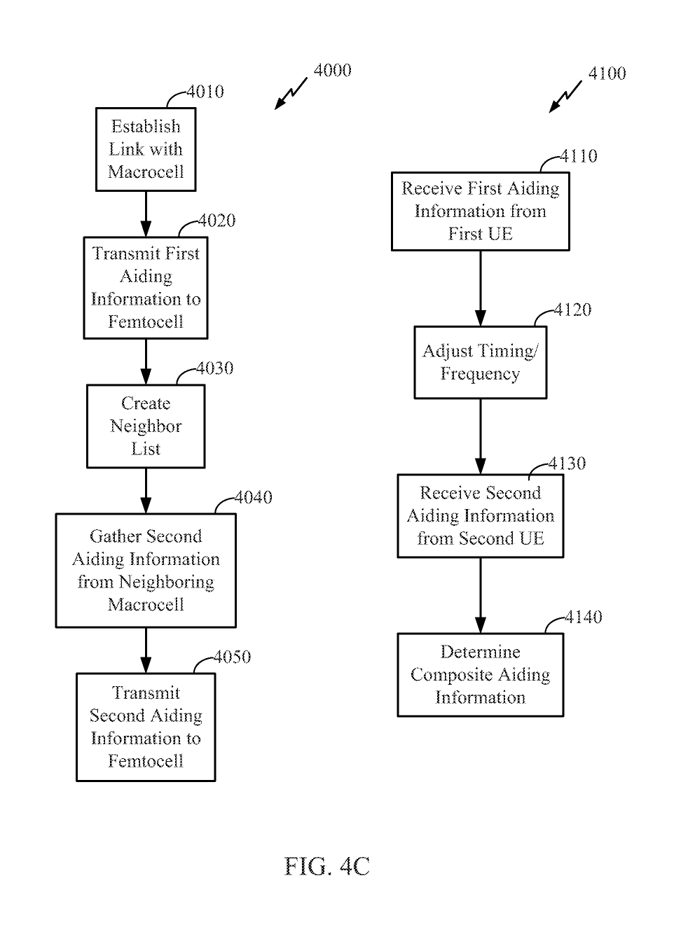

FIG. 4A is a conceptual block diagram that illustrates one example of the femtocell unit 310 shown in FIG. 3. In the figure, a number of blocks are labeled as processors or controllers. Those skilled in the art will comprehend that each of these processors may be implemented as hardware processors such as the processor 104 or the processing system 114 illustrated in FIG. 1, or alternately, the functions performed by any number of the illustrated processors may be combined into and implemented by a single hardware processor. Further, the illustrated processors in FIG. 4 may represent functions to be implemented by processors, software, or the like.

As noted above, the femtocell unit 310 may include a network listen component 370. The network listen component 370 generally functions like the eyes and ears of the femtocell unit 310 to configure the femtocell unit 310 and retrieve timing and frequency information for synchronization. The network listen component 370 may include a downlink receiver 371 and a receive processor 372 for receiving and measuring signal and interference levels on various available channels. The network listen component 370 may further utilize the receiver 371 and receive processor 372 to acquire timing and frequency information from neighboring cells and decode broadcast messages from those cells for mobility and interference management purposes. For example, the network listen component 370 may achieve this by periodically scanning the surrounding cells. The femtocell unit 310 may further include wireless wide area network (WWAN) components including a WWAN transceiver 311 and WWAN processor 312, and wireless personal area network (WPAN) components including a WPAN transceiver 313 and WPAN processor 314. Here, the WPAN components are optional, and may be utilized for low-power, out-of-band communication with a UE in proximity to the femtocell unit 310. The femtocell unit 310 may further include a backhaul I/O unit 316 for facilitating communication with a modem 400, which may be internal or external to the femtocell unit 310, a controller/processor 315 for controlling and coordinating the various functionalities of the femtocell unit 310, and a memory 317 for storing information for utilization by the controller/processor 315.

Because the network listen component 370 may only include receiver functions, the transmission functions of the femtocell unit's WWAN transceiver 311 and WPAN transceiver 313 are generally turned off in order for the network listen component 370 to operate. This implies that any UE 320 camped on the femtocell unit 310 (hereinbelow referred to as a Home Node B UE or HUE) will not be served by the femtocell unit 310 during the period when the network listen component 370 is scanning. Consequently, it may be desired that the scanning periodicity of the network listen component 370 has minimal impact on the HUEs 320 camped on the femtocell unit 310, while attempting to guarantee that the latest information gathered from neighboring macrocells is not obsolete until the next time the network listen component 370 performs a scan. This is a challenging tradeoff to achieve.

FIG. 4B is a block diagram illustrating a UE 410 according to an exemplary aspect of the disclosure. In the figure, a number of blocks are labeled as processors or controllers. Those skilled in the art will comprehend that each of these processors may be implemented as hardware processors such as the processor 104 or the processing system 114 illustrated in FIG. 1, or alternately, the functions performed by any number of the illustrated processors may be combined into and implemented by a single hardware processor. Further, the illustrated processors in FIG. 4B may represent functions to be implemented by processors, software, or the like. Here, the UE 410 may include a WWAN transceiver 420 and WWAN processor 430; as well as a WPAN transceiver 440 and a WPAN processor 450. Accordingly, the UE 410 may be configured to establish a WWAN link and/or a WPAN link with the femtocell unit 310. Further, the UE 410 may include an I/O for accepting user input, for example, from a keypad (not illustrated) and providing output, for example, to a display (not illustrated). Further, the UE 410 may include a controller/processor 460 for controlling the various functions of the UE 410, and a memory 480 for storing information for use by the controller/processor 460.

The 3GPP standards for femtocells (i.e., HNBs and HeNBs) allow the HUEs 320 to provide information (e.g., timing and frequency synchronization information) about surrounding macrocells to that femtocell. However, these HUEs 320 might be at the cell center of a macrocell, or may be at other locations such as an edge of a macrocell, potentially making the information provided from the target macrocell noisy and less valuable to the femtocell.

Thus, in an aspect of the present disclosure, the femtocell unit 310 may utilize signals from other UEs that are not camped on the femtocell but are instead camped on the neighboring macrocell of interest (hereinbelow referred to as macrocell UEs or MUEs). Because those MUEs are in communication with the neighboring macrocells, that communication relies on the MUEs having accurate timing with respect to the corresponding macrocells serving them. Thus, these MUEs are a reliable source of such information for the femtocell to use.

FIG. 4C illustrates two flow charts showing two complementary processes 4000 and 4100 that illustrate an example of an MUE-assisted approach for providing aiding information to a femtocell. Process 4000 illustrates a procedure for a MUE to provide the aiding information. Here, in step 4010, the MUE may establish a conventional link with a macrocell, for example, utilizing a WCDMA air interface, a CDMA2000 air interface, or any other suitable air interface. In step 4020, the MUE may transmit first aiding information to a femtocell. Here, the transmission of the aiding information to the femtocell may occur while the MUE maintains the communication link with the macrocell established in step 4010. Further, the transmission of aiding information may be undertaken utilizing a different communication interface than the wireless link established in step 4010, for example, a long-range air interface, a short-range air interface such as a PAN interface, or any other suitable wired or wireless interface. The aiding information transmitted in step 4020 may include timing information, frequency synchronization information, or any other suitable information gathered from the macrocell with which the link was established in step 4010. In step 4030, the MUE may create a neighbor list for listing neighboring cells. In one example, the neighbor list may include the femtocell to which the aiding information was transmitted in step 4020. In step 4040, the MUE may gather second aiding information from a neighboring macrocell (e.g., one of the macrocells listed in the neighbor list established in step 4030), and in step 4050, the MUE may transmit the second aiding information to the femtocell. For example, the transmission in step 4050 may utilize the same communication interface utilized in step 4020 to transmit the first aiding information to the femtocell. In another example, any suitable communication interface may be utilized in step 4050 to transmit the second aiding information to the femtocell. As will be fully comprehended in the description of the process 4100, the second aiding information may be combined with the first aiding information to determine composite aiding information, improving the accuracy, for example, of timing or frequency synchronization information.

Process 4100 is an example of a procedure for a femtocell to receive aiding information from one or more MUEs. In step 4110, the femtocell receives first aiding information from a first MUE. In one example, this step may correspond to the transmission 4020 of first aiding information to a femtocell in process 4000. That is, the femtocell may receive the first aiding information over any suitable communication link, such as a long-range wireless link, a short-range wireless link such as a PAN interface, or any other suitable wired or wireless communication link. Here, the first aiding information may correspond to at least one cell of a plurality of cells in a wireless communication network, e.g., one with which the MUE has established a communication link. In step 4120, the femtocell may adjust a reference timing and/or a frequency in response to the first aiding information. In step 4130, the femtocell may receive second aiding information from a second MUE. The term “second” here may be broadly construed, and the second MUE may be the same MUE as the first MUE, or may be a different MUE from the first MUE. In any case, the second aiding information may be timing and/or synchronization information corresponding to a second macrocell in the wireless communication network. In step 4140, the femtocell may determine composite aiding information based on the first aiding information and the second aiding information. For example, the femtocell may determine an average of first and second timing or frequency offsets.

There are several potential sources of error when transferring timing and frequency synchronization information from one node to another, for example, from a macrocell to a femtocell unit. These sources of error include propagation delay between the source node and destination node, oscillator drift at the destination node, measurement or calibration errors, such as timing and frequency errors, and algorithmic errors. To mitigate these errors and facilitate the transfer of timing and frequency synchronization information from a neighboring macrocell to a femtocell, an aspect of the instant disclosure provides an approach for sniffing uplink transmissions to obtain various aiding information from MUEs. This approach differs from prior approaches, some of which used the network listen component of the femtocell to measure timing and synchronization information transmitted on downlink channels from neighboring macrocells.

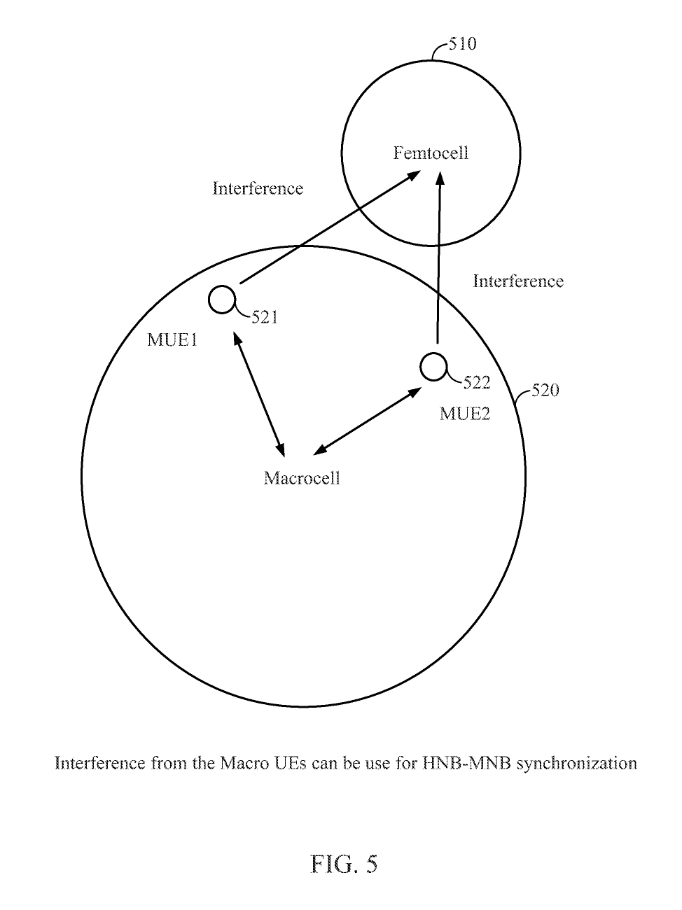

FIG. 5 is a conceptual diagram illustrating a system in which some aspects of the present disclosure may be implemented. Here, a femtocell 510 is located in the general vicinity of a neighboring macrocell 520. To illustrate the example, two MUEs 521 and 522 are camped on the macrocell 520, which concomitantly acts as their serving cell. That is, the MUEs 521 and 522 configured to receive downlink transmissions in accordance with scheduling resources provided by the macrocell 520, and are broadcasting uplink transmissions intended to be received and decoded by the macrocell 520. However, as the antennas of the MUEs 521 and 522 may not be directional in nature, if the MUEs 521 and 522 are located proximally to the femtocell 510, the uplink transmissions may be received at the femtocell. Ordinarily, uplink transmissions from the MUEs 521 and 522 would be considered as undesirable interference with respect to the WWAN transceiver and the network listen module of the femtocell unit servicing the femtocell 510. However, in accordance with some aspects of the present disclosure, the femtocell may sniff these uplink transmissions to obtain aiding information, such as to synchronize timing and frequency of the femtocell. In accordance with another aspect of the present disclosure, the MUEs 521 and 522 may direct a broadcast to the femtocell to provide the aiding information.

That is, according to some aspects of the present disclosure, an MUE 521 camped on a macrocell 520 may read system information blocks (SIBs) transmitted on a downlink from the macrocell 520 in order to acquire information such as timing and synchronization information. For an MUE 521 close to a particular femtocell 510, e.g., where the femtocell 510 is included in the MUE's neighbor list, the MUE 521 may send aiding information, such as timing and frequency information for its serving cell, and in some aspects, other cells in its neighbor list, to the femtocell 510. The MUE 521 may provide the aiding information to the femtocell 510 by breaking communication between the MUE 521 and the macrocell 520 and then sending the message to the femtocell 510 utilizing the WWAN link. In another aspect, the transmission of the aiding information from the MUE 521 to the femtocell 510 may be performed over an out-of-band (OOB) link to avoid taking up extra capacity on the wireless wide area network (WWAN). For example, the transmission from the MUE 521 may utilize a WPAN protocol (e.g., an IEEE 802.15 link) to be received by the WPAN transceiver 313 in the femtocell unit 310 (see FIG. 4). In another example, the OOB transmission from the MUE 521 may utilize any suitable wired or wireless link that is different from the WWAN link.

In a further aspect of the disclosure, the femtocell 510 may collect the aiding information such as timing and synchronization information from multiple such MUEs and utilize the measurements to determine the timing and synchronization information of a plurality of macrocells of interest. In yet a further aspect of the disclosure, the aiding information forwarded to the femtocell 510 may include interference-related information that can be used for interference management by the femtocell 510.

In this MUE-assisted approach, measurements of timing and synchronization may be obtained from multiple MUEs, and hence, the multiple measurements can be used by the femtocell 510 to reduce timing and synchronization errors when compared to measurements taken by a single source. In addition, the femtocell 510 may use these measurements as complementary measurements (for example, by calculating an average) to increase the accuracy of measurements taken by the network listen component 370 and connected HUEs.

In another aspect of the disclosure, the femtocell 510 may sniff uplink packets transmitted by MUEs (e.g., packets directed to the macrocell 520), and may retrieve aiding information such as timing and synchronization information of the particular macrocell 520 serving the respective MUEs based on the sniffed uplink packets. That is, packets transmitted by MUEs directed to neighboring cells, which otherwise are considered as interference by a femtocell, may be utilized by the femtocell to improve the timing and/or synchronization of the femtocell. Compared to the above-described MUE-assisted approach, this femtocell-derived approach is somewhat more limited, because in general, only the timing and synchronization information corresponding to the MUE's serving macrocell can be extracted from such uplink transmissions, whereas in the MUE-assisted approach, the MUEs may provide the femtocell with information from a plurality of its neighboring cells.

According to various aspects of the disclosure, the aiding information retrieved by sniffing the uplink transmissions from MUEs may be utilized for refining coarse timing estimates obtained by other means, for example, utilizing the backhaul I/O module 316, the network listen component 370, or any other source of coarse timing information.

Here, the femtocell unit 310 sniffs packets from MUEs that are transmitting packets. In UMTS, MUEs that are transmitting packets may be in the CELL_FACH or CELL_DCH mode. In other connected modes such as the URA_PCH or the CELL_PCH states, the MUE is not transmitting packets on the uplink. Similarly, in idle mode, the MUE is also not transmitting packets on the uplink so the femtocell unit cannot sniff packets from UEs in those states.

In order to sniff an uplink packet transmitted by a UE in the CELL_FACH state, the femtocell unit may utilize the scrambling code, spreading code, and signature used by the MUE in its uplink transmissions. The signatures and code numbers are included in the system information block SIB5 in a macrocell, and can be obtained by the network listen entity.

That is, to sniff packets from an MUE in the CELL_FACH state, the network listen entity in the femtocell unit may obtain SIB 5 information from the target macrocell. With this information, the femtocell unit may extract signatures (e.g., a signature index), spreading codes (e.g., OVSF codes), and scrambling codes for the MUEs in CELL_FACH from SIB 5. Thus, the femtocell unit may utilize that information to obtain timing and frequency information from uplink packets transmitted by the MUEs.

In order to sniff an uplink packet transmitted by an MUE in the CELL_DCH state, the femtocell unit similarly utilizes the scrambling code, spreading code, and timing offset information used by the MUE in its uplink transmissions. However, because the Node B does not broadcast the SIBs during the CELL_DCH state, this information may be obtained from the radio bearer configuration, radio bearer reconfiguration, or radio bearer setup messages. A femtocell unit in the MUE's Active Set will generally have access to such information. However, for a femtocell unit not in the MUE's Active Set, the information may be obtained from the radio network controller (RNC) or neighboring cells (e.g., Node Bs that are in the MUE's Active Set).

That is, to sniff packets from MUEs in the CELL_DCH state, the femtocell unit obtains spreading codes, scrambling codes, and timing offset information from the RNC or other macrocells (e.g., utilizing a backhaul connection to the RNC or macrocell), and the femtocell unit utilizes this information to sniff the packets and obtain the timing and frequency information.

CELL_FACH

In the CELL_FACH state, the MUE may be transmitting a preamble to gain access to the channel, or transmitting data to the network. If transmitting a preamble, the MUE uses the physical random access channel (PRACH). MUEs in the CELL_FACH state, which support Release 7 of the 3GPP family of standards and earlier releases of UMTS, may transmit data only on the PRACH, however, for later releases the MUE may use the enhanced uplink dedicated channel dedicated physical control channel (E-DPDCH) for transmitting high data rate uplink messages.

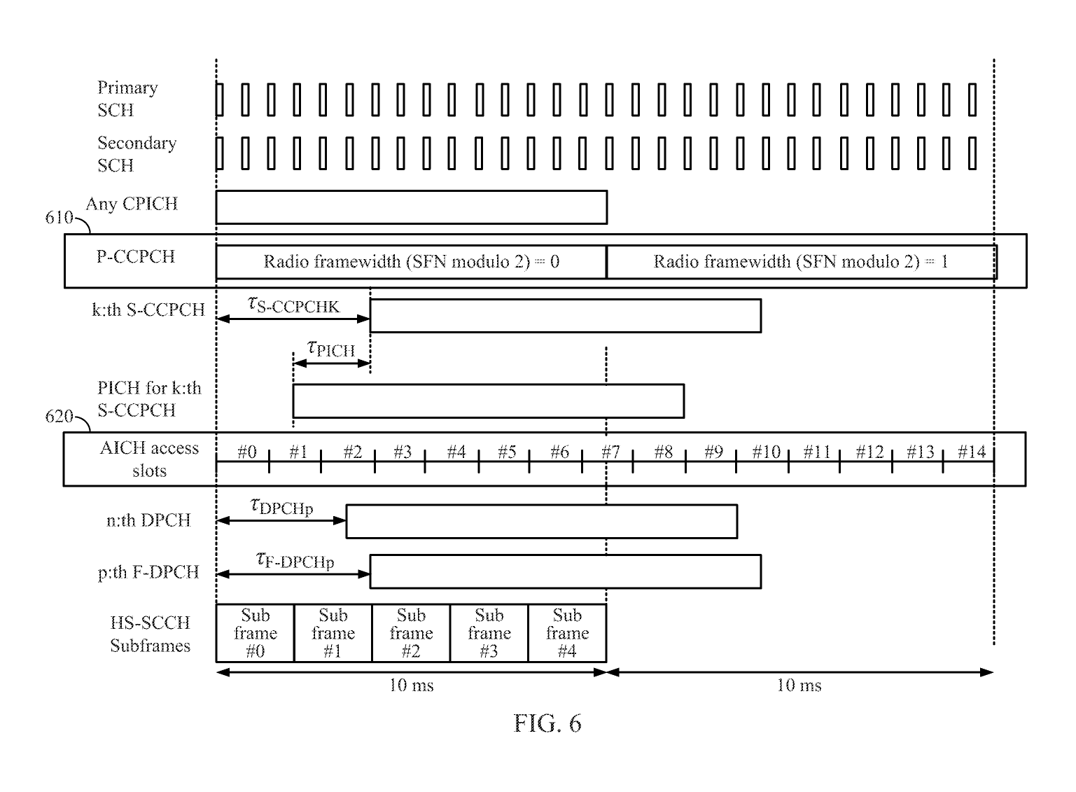

FIG. 6 is a timing diagram that conceptually illustrates some of the channels discussed herein. In UMTS, the primary common control physical channel (P-CCPCH) 610 is the timing reference for all physical channels in a particular cell, directly for the downlink and indirectly for the uplink. Therefore, in order to obtain the timing reference of the macrocell, the timing relationship between the PRACH or the E-DPDCH the MUE is using for uplink transmissions and the P-CCPCH of the macrocell is derived. This timing relationship is derived from the acquisition indicator channel (AICH) 620, i.e., the downlink channel carrying the macrocell's ACK/NAK response to preambles. The AICH 620 has 15 slots labeled #0-#14, which overlap two P-CCPCH frames including 30 regular slots. The start of the AICH access slot #0 aligns with the start of P-CCPCH subframe number (SFN) modulo 2=0.

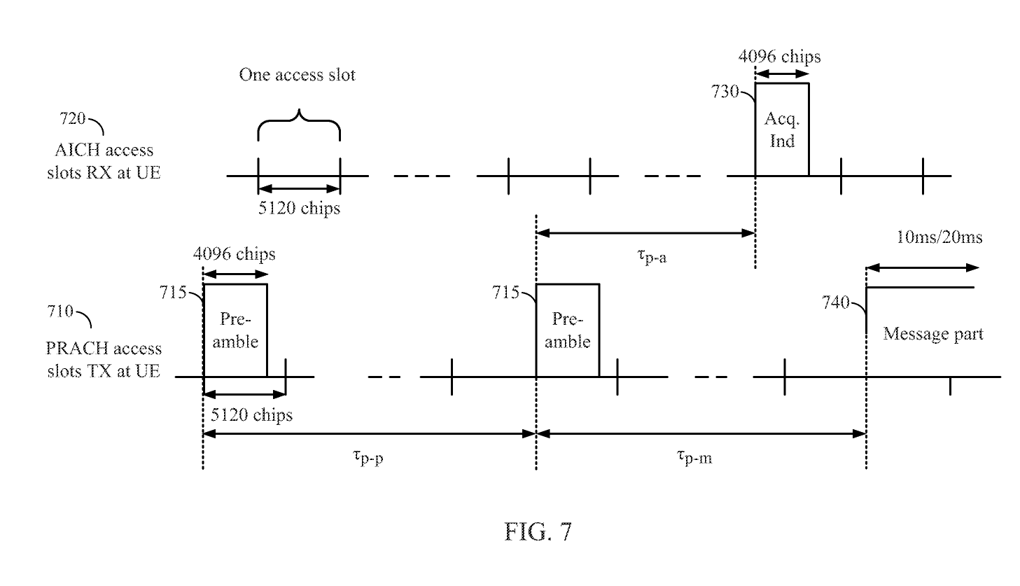

For each preamble transmitted in an uplink access slot there is a corresponding access slot from which the MUE expects to receive an ACK/NAK from the network. In the event that an ACK was received, the timing of the MUE's uplink data transmission (called the message part) is tied to the PRACH and AICH channel timing as shown in FIG. 6. FIG. 7 shows the PRACH 710, the AICH 720, and the access slot the MUE uses for transmission. Here, preambles 715 are 4096 chips long in slots that are 5120 chips wide. The time difference between the transmitted preamble and an expected ACK/NAK on the AICH is depicted as τₚ₋ₐ in FIG. 7.

If an ACK 730 is received on the AICH channel 720, then a message 740 of length 10 or 20 ms (data) is transmitted with a time difference of τₚ₋ₘ from when the original preamble was sent. If a NAK is received, then another preamble 715 is transmitted τₚ₋ₚ seconds after the previous preamble 715 was sent. The values for τₚ₋ₚ, τₚ₋ₘ, and τₚ₋ₐ depend on a parameter called the AICH Transmission Timing (ATT), which may takes on a value of 0 or 1. The value of the ATT parameter is derived from the cell broadcast information and the MUE's access service class (ASC). The typical values for τₚ₋ₚ, τₚ₋ₘ, and τₚ₋ₐ are presented in Table 1 below.

TABLE 1

| | AICH Trans. | AICH Trans. |
|---|---|---|
| | Timing = 0 (chips) | Timing = 1 (chips) |
| τ_{p-p, min} | 15360 | 20480 |
| τₚ₋ₐ | 7680 | 12800 |
| τₚ₋ₘ | 15360 | 20480 |

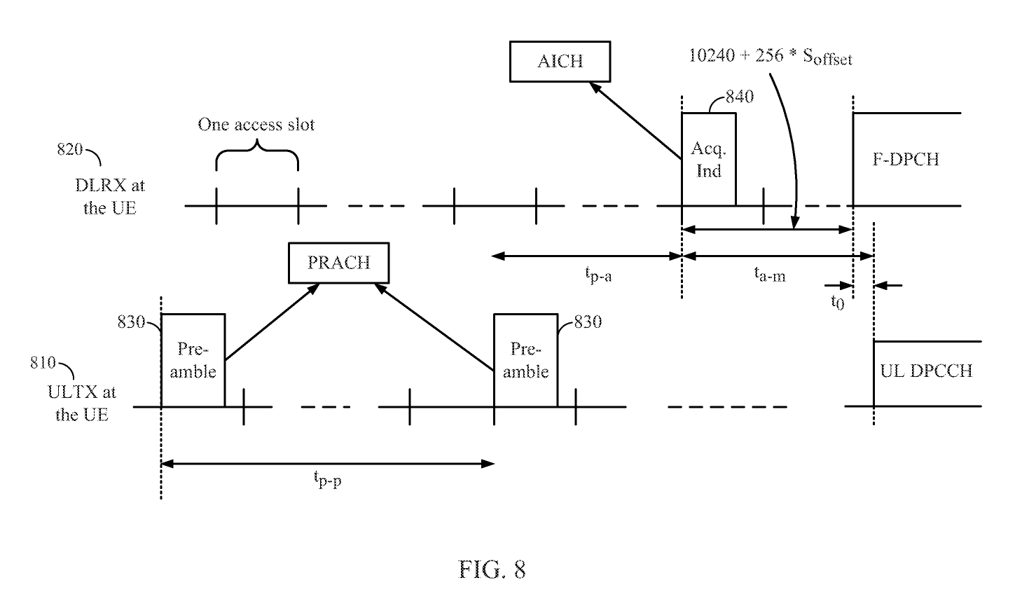

As mentioned above, MUEs in the CELL_FACH state supporting Release 8 and beyond are allowed to transmit data with a high data rate on the E-DPDCH, which may be 2 ms or 10 ms long. The transmission of E-DPDCH on the uplink 810 relies on the transmission of dedicated physical control channels, i.e., E-DPCCH and UL DPCCH. When MUEs transmit on the E-DPDCH, the E-DPDCH and E-DPCCH are frame aligned with UL DPCCH. The UL DPCCH timing is tied to the timing of downlink channels 820 received during the preamble transmission and acknowledgement. These timing relationships are illustrated in FIG. 8. Further, the values of the timing parameters illustrated in FIG. 8 are shown in Table 2 below.

The timing relationship between an MUE's preamble transmission 830 on the PRACH and acknowledgement 840 on the AICH is the same as discussed previously, the difference here being when data can be transmitted after the reception of the ACK 840. After an ACK 840 is transmitted on the AICH, the Node B transmits control information to the MUE using the fractional dedicated physical channel (F-DPCH). The F-DPCH is transmitted 10240+256×S_{offset} chips from the start of the AICH channel. Here, S_{offset} is an MUE-dependent offset chosen by the network and used in staggering F-DPCH transmissions to multiple UEs so as to prevent overlaps. The range of S_{offset} is shown in Table 2.

TABLE 2

| | AICH Trans. | AICH Trans. |
|---|---|---|
| | Timing = 0 (chips) | Timing = 1 (chips) |
| τ_{p-p, min} | 15360 | 20480 |
| τₚ₋ₐ | 7680 | 12800 |
| τₚ₋ₘ | 15360 | 20480 |

| | |
|---|---|
| τₐ₋ₘ | 10240 + 256 × S_{offSet} + τ₀ chips |
| τ₀ | 1024 |
| S_{offset} | 0, 1, . . . , 9 |

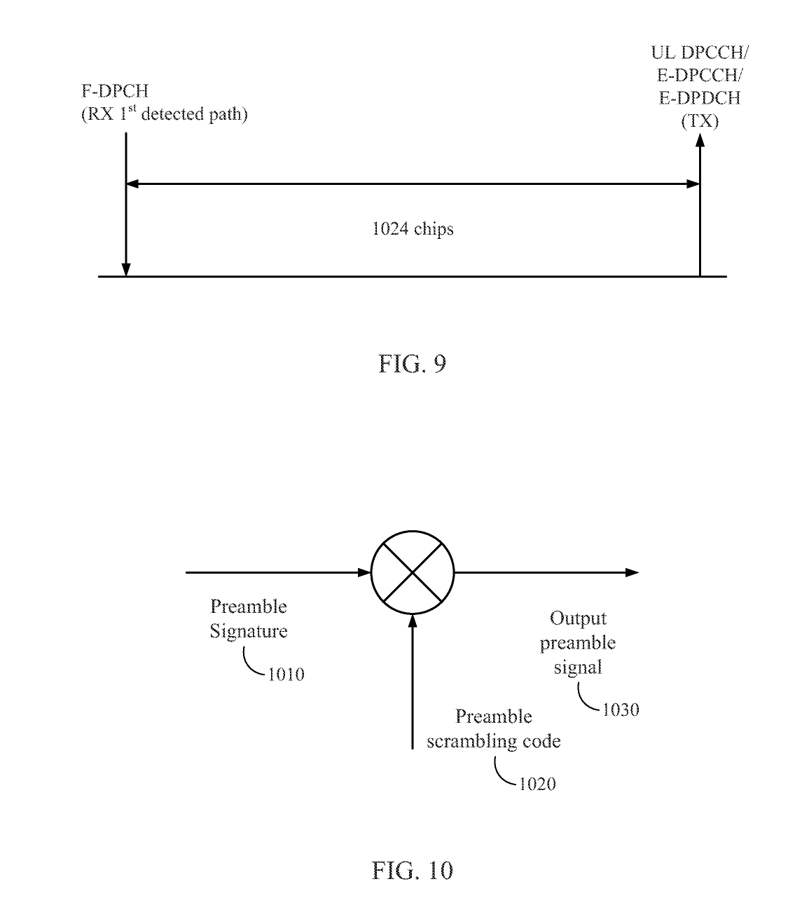

Once the MUE receives the F-DPCH, the MUE sends its corresponding uplink transmission in the UL DPCCH τ₀ (1024) chips afterward, as shown in FIG. 9.

While sniffing the MUEs' uplink packets in the CELL_FACH state, the network may determine whether the packet is a PRACH preamble, a PRACH message, or UL DPCCH (for release 8 and beyond UEs). The femtocell unit may determine the type of transmission based on the packet structure of each of the transmissions. The PRACH preamble, PRACH message, and UL DPCCH structure are discussed below.

The PRACH preambles 1030 are generated by the multiplication of a preamble signature 1010 with a scrambling code sequence 1020 as illustrated in FIG. 10.

There are sixteen possible preamble signatures available in a particular cell. Each signature is made up of a 16-chip sequence repeated 256 times. While the indices of the available signatures are typically broadcasted in system information block (SIB) 5, the subset available to a particular UE is derived based on the UE's ASC. In event that the ASC information is not available to the femto sniffing uplink packets, the femto would have to search through all sixteen signatures to find the particular signature that was used by the UE in generating the preamble signal.

The scrambling code used for the PRACH preamble is selected from a group of 8192 sequences divided into 512 code groups with 16 codes per group.

Hence, the preamble scrambling code can be expressed as a code with index n, where n=m×16+k, where in is the index identifying the code group with values within the range 0, 1, . . . , 511 and k, and the specific code number within each group value is in the range of 0, 1, . . . , 15. The code group index has a one-to-one relationship with the primary scrambling code used by the cell (the macrocell in this case). Further information regarding these codes may be found in 3GPP TS25.213 section 4.3.3.2, incorporated herein by reference. The code number k is broadcasted in SIB 5.

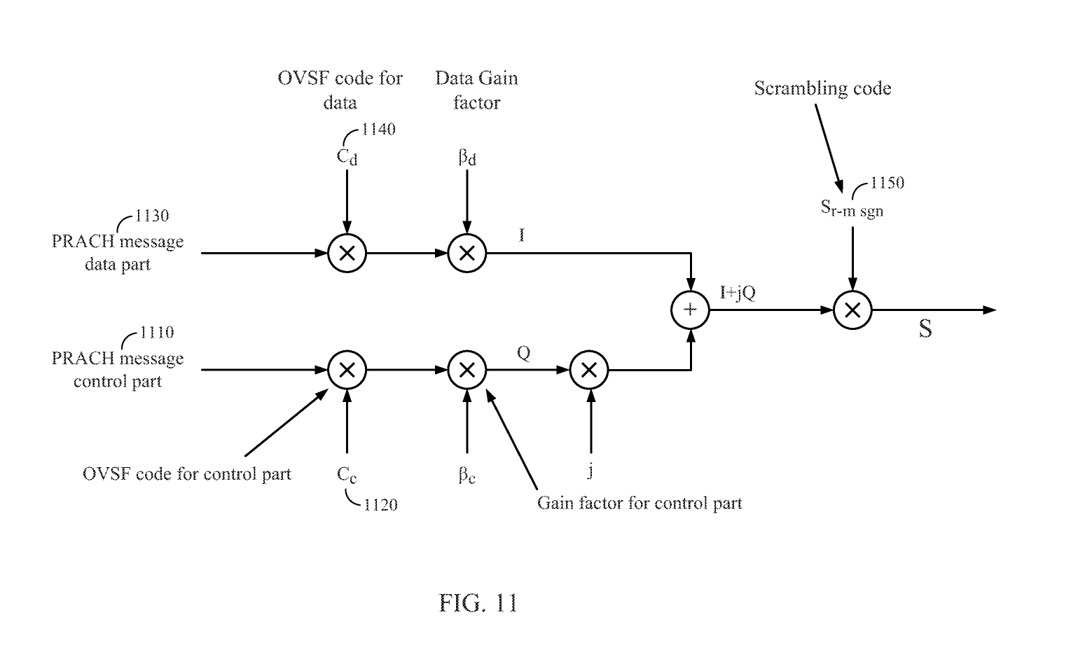

The PRACH message is made of data and control information masked with the orthogonal variable spreading factor (OVSF) spreading and scrambling codes as shown in FIG. 11.

The control part 1110 carries an 8-bit pilot pattern used for channel estimation at the Node B. There are 14 such patterns defined 3GPP TS25.211 section 5.2.2.1.3, incorporated herein by reference. The pilot pattern used in each slot can vary from slot to slot.

The OVSF code 1120 used for the control part has a fixed spreading factor of 256 given as C_{256,m}, where m=16×s+15, and s is the index of the preamble signature, discussed above, which values ranging from 0, 1, . . . , 15. The OVSF code 1140 for the data part 1130 is based on the spreading factor (SF) used for transmission, i.e., 256, 128, 64 and 32. The OVSF code 1140 can be expressed as C_{SF,m} where m=SF×s/16. Further information about OVSF codes may be found in 3GPP TS25.213, section 4.3.1.3, incorporated herein by reference.

The scrambling code 1150 used for the PRACH message part may have a direct one to one mapping with the scrambling code used in scrambling the PRACH preamble.

Given that the search space for the data part is higher than the data, it is recommended that the OVSF code 1120 for the control part be used in the femtocell search during sniffing. The pilot sequence could also be employed in the search but since the pilot sequence can change every slot, it is therefore not efficient to use the pilot sequences.

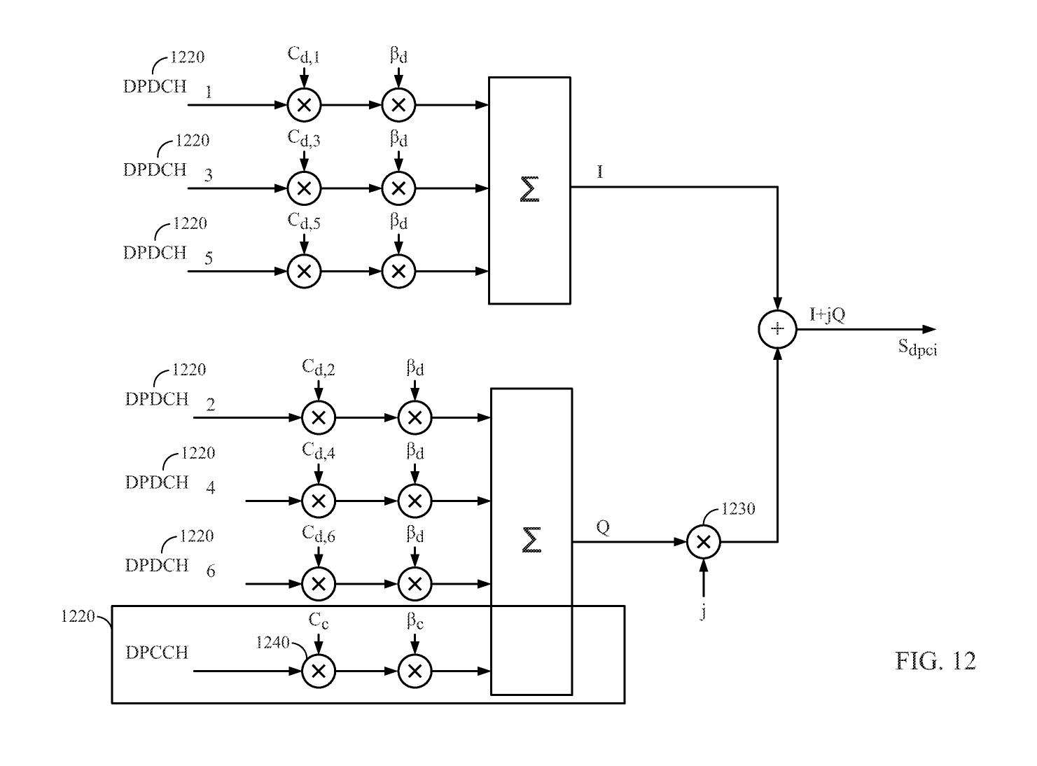

FIG. 12 is a block diagram that illustrates UL DPCCH and UL DPDCH physical layer processing during transmission. It is noteworthy that although the gain factors are applied during transmissions as shown in FIG. 12, the femtocell unit may not be required to know the gain factors during detection.

The UL DPCCH contains control bits such as pilot sequences used for channel estimation and synchronization. There are six possible pilot patterns used in the UL DPCCH. The specific pattern used for transmission is typically signaled to the MUE from the network.

The UL DPCCH may be transmitted alone or with other channels such as the E-DPDCH, E-DPCCH, and UL DPDCH. The transmission of UL DPCCH 1210 with the UL DPDCH 1220 is shown in FIG. 12. The UL DPCCH 1210 may be transmitted on the quadrature component 1230 and spread using a known OVSF code 1240 with SF 256 and index 0, C_{256,0}. After data scaling with the beta factor and combining with the in-phase component (if transmitted with other channels), the UL DPCCH 1210 is scrambled using a UE specific scrambling code.

CELL_DCH

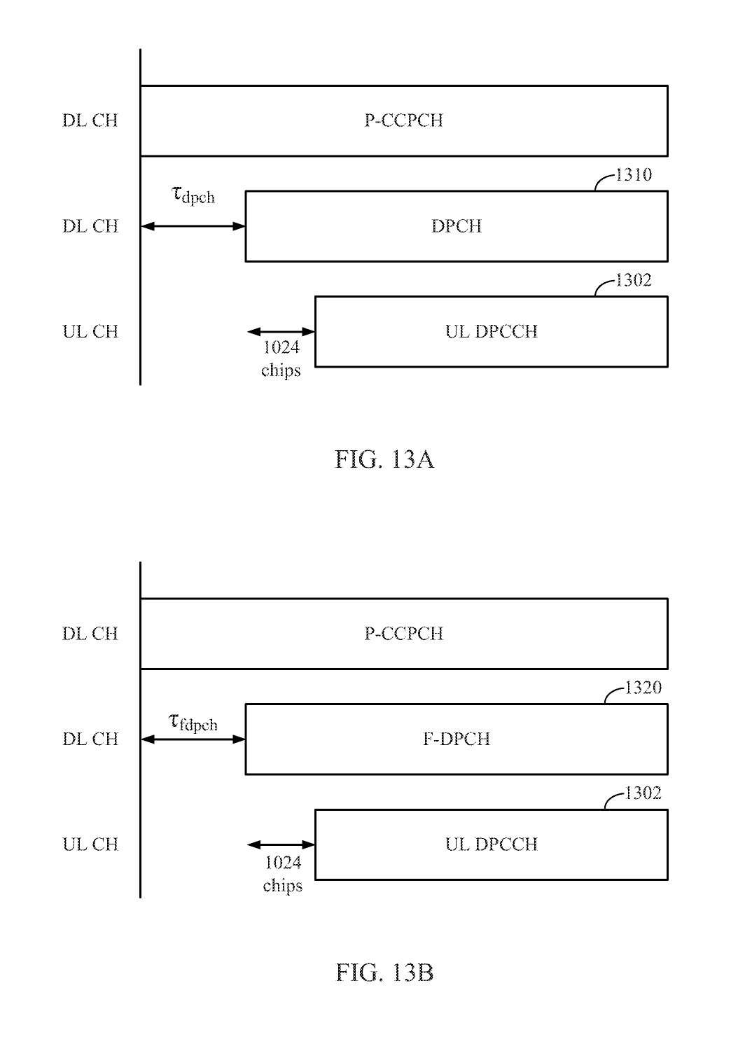

In the CELL_DCH state, the MUE is actively exchanging data with the network. Similar to the CELL_FACH state described above, the timing reference for uplink transmission is the UL DPCCH 1302. The timing of the UL DPCCH 1302 is derived from the timing of the DPCH 1310 or the F-DPCH 1320 as shown in FIGS. 13A and 13B, respectively. Here, the DPCH 1310 and F-DPCH 1320 have τ_{DPCH} and τ_{F-DPCH} timing offsets from the cell P-CCPCH, respectively. Further, the τ_{DPCH,n}=Tₙ×256 chips, and the τ_{F-DPCH,p}==Tₚ×256 chips, where Tₙ, Tₚ is in the range {0, 1, . . . , 149}.

The scrambling code index, beta factors, and τ_{DPCH} and τ_{F-DPCH} offsets corresponding to the UL DPCCH are typically signaled to the UE from the Node B through the Radio Bearer Configuration (RB Config.) or the Radio Bearer Reconfiguration (RB Re-config.) message.

Detection Parameters Used for Sniffing

With the above information, the femtocell unit 310 may sniff uplink transmissions from MUEs to obtain aiding information. The parameters utilized by the femtocell unit 310 for detection of the uplink transmissions, possible values of those parameters, and the sources of those values are presented in Table 3.

TABLE 3

| Detection Parameter | Possible Values | UE source of Information |
|---|---|---|
| UE state | CELL_FACH/CELL_DCH | Signaled to UE in the RRC |
| | | connection set-up, RB |
| | | configuration or RB |
| | | reconfiguration message |
| UE Type | Pre-release 5, Release 5, | Information is internal to UE |
| | 6, 7, 8, 9 | but communicated to the |
| | | network during UE capability |
| | | information exchange |

PRACH Detection

| | | |
|---|---|---|
| ATT Parameter | 0, 1 | Obtained from SIB 5/5 bis |
| ASC Parameter | 0, 1, . . . , 7 | Determined by UE based |
| | | information from SIB 5 or 5 bis |
| | | and USIM information |
| Preamble signature | s = 0, 1, . . . , 15 | Available set is signaled |
| | | through in SIB 5/5 bis but UE |
| | | randomly selects a sequence |
| Preamble Scrambling code | 0, 1, . . . , 511 | Tied to PSC on serving cell |
| group | | signaled. PSC is derived |
| | | during UE synchronization |
| Preamble code Number | k = 0, 1, . . . , 15 | Obtained from SIB 5/5 bis |
| Pilot bit pattern for the PRACH | 14 possible bit patterns | Value is signaled from the |
| message control Part | | network to UE |
| OVSF code for the PRACH | C_{256, m}, where m = 16 × s + | Depends on the selected |
| message control part | 15, and s = 0, 1, . . . , 15 | preamble signature |
| OVSF codes for the PRACH | C_{SF, m} = SF × s/16, where s = | SF is chosen by UE based on |
| message data part | 0, 1, . . . , 15, and SF = 32, | data rate. |
| | 64, 128, 256 | s is based on selected |
| | | preamble signature |

UL DPCCH Detection

| | | |
|---|---|---|
| Pilot bit pattern for the UL | 6 possible bit patterns | Signaled to UE in the RB |
| DPCCH | | configuration or RB |
| | | reconfiguration message |
| OVSF code for UL DPCCH | One option — C_{256, 0} | Fixed |
| Scrambling code for UL | 2²⁴ options | Signaled to UE in the RB |
| DPCCH | | configuration or RB |
| | | reconfiguration message |
| Time offsets — τ_{DPCH} and τ_{F-DPCH} | τ_{DPCH, n} = Tₙ × 256 chip | Signaled to UE in the RB |
| | τ_{F-DPCH, p} = Tₚ × 256 | configuration or RB |
| | Tₙ, Tₚ is in the range {0, | reconfiguration message |
| | 1, . . . , 149} | |
| S_{offset} | {0, 1, . . . , 9} | Value is signaled from the |
| | | network to UE |

Almost all the parameters presented in Table 3 are provided from the macrocell to the MUE in a broadcast or dedicated message, with the exception of the preamble signature, which is randomly selected by the MUE. Therefore, if the femtocell unit 310 obtains all other required information from the network, it may search through the possibilities of the preamble signature during PRACH detection. When parameters are obtained from the network, they may be obtained via a backhaul connection from network nodes such as the Radio network controller (RNC).

If only a subset of the information is available, then the femtocell unit 310 may perform an exhaustive search of the possibilities of the unknown parameters to retrieve the macrocell timing information. Since the search space of the UL DPCCH scrambling code for the UE is very large (i.e., 2²⁴), a system may benefit if the UL DPCCH detection is used when the UL DPCCH scrambling code of the MUE is known.

Slot and Frame Timing Determination

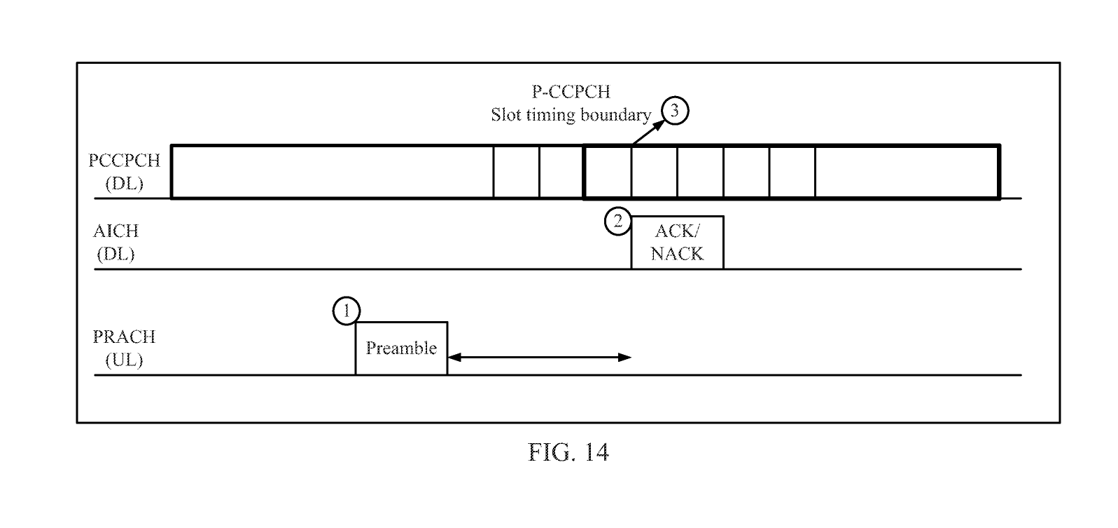

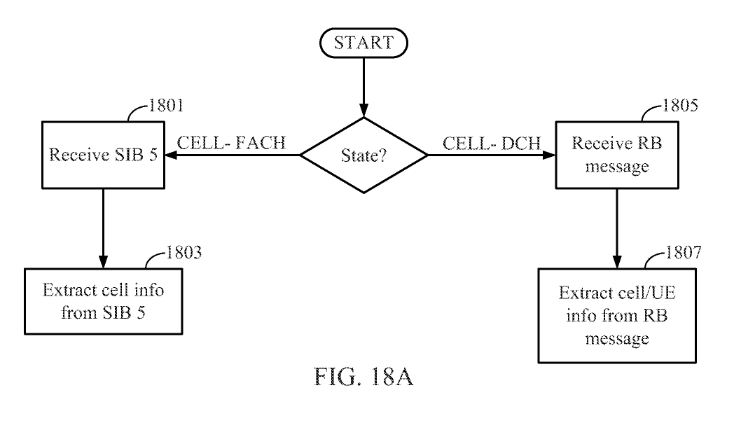

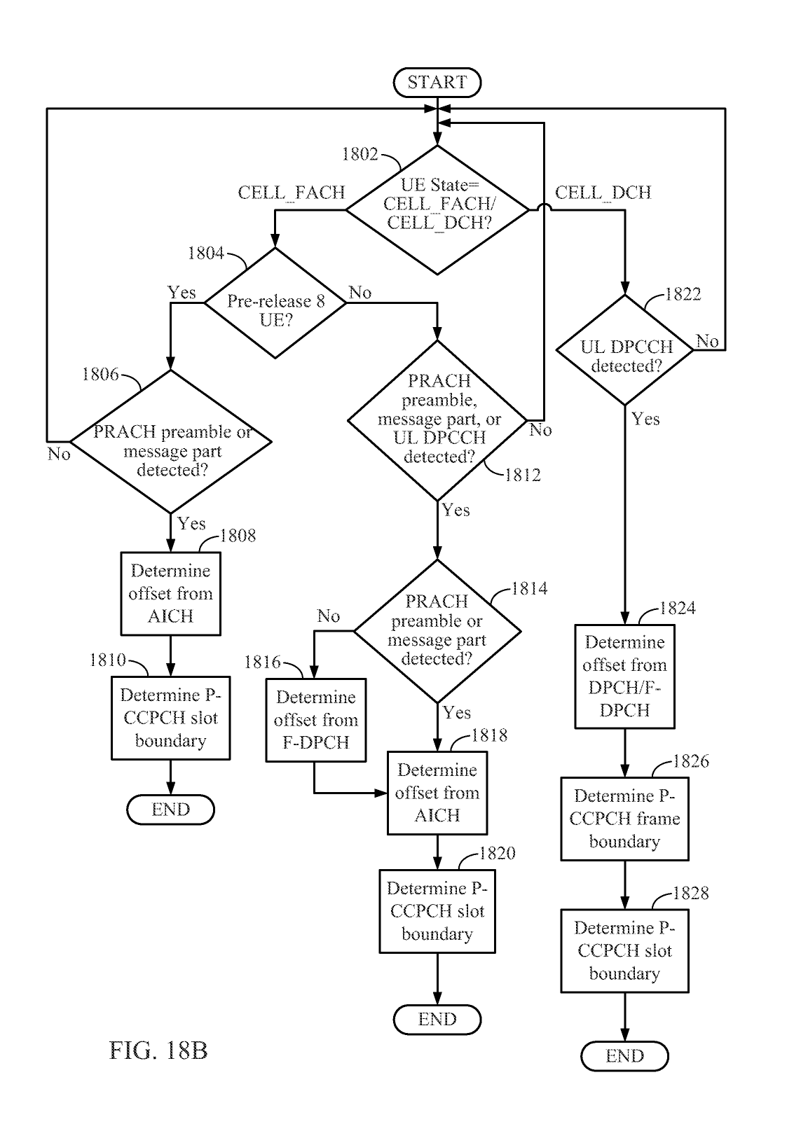

The detection of the slot or the frame timing of the P-CCPCH using the PRACH preamble and PRACH message part in CELL_FACH, UL DPCCH in CELL_FACH and UL DPCCH in CELL_DCH are illustrated in FIGS. 14-17. In each figure, the order of the steps used for the determination of the slot timing of the P-CCPCH is also noted. A flow chart illustrating each of these detection processes is presented in FIG. 18B. FIG. 18A illustrates a general process illustrating details of a preliminary procedure prior to the determination of the slot or the frame timing.

In FIG. 18A, the process depends on the state in which the MUE exists. If the MUE is in the CELL_FACH state, then in block 1801, the process receives detection parameters, for example, utilizing a backhaul connection to retrieve the information from a network node such as a neighboring Node B or an RNC. In block 1803, the process extracts information about the cell from the SIB information retrieved in block 1801, to be utilized for the reception of uplink information from the MUE as illustrated in FIG. 18B. If the MUE is in the CELL_DCH state, then in block 1805, the process receives detection parameters, for example, utilizing a backhaul connection to retrieve the information from a network node such as a neighboring Node B or an RNC. In block 1807, the process extracts information about the cell and the UE from the radio bearer message retrieved in block 1805, to be utilized for the reception of uplink information from the MUE as illustrated in FIG. 18B.

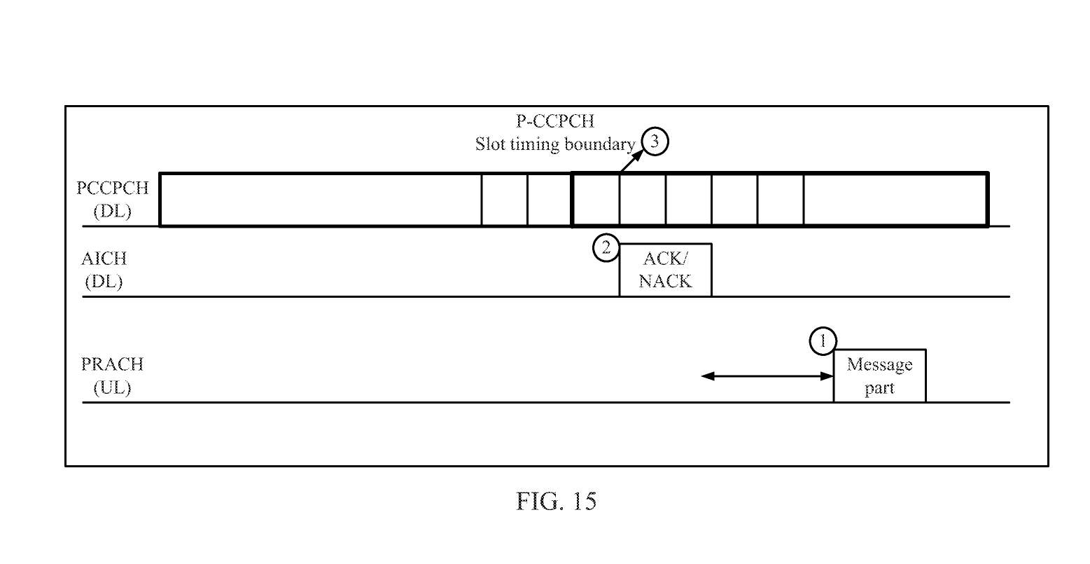

FIG. 14 illustrates the determination of the slot timing of the P-CCPCH using the PRACH preamble in the CELL_FACH state. FIG. 15 illustrates the determination of the slot timing of the P-CCPCH using the PRACH message part in the CELL_FACH state. As shown in FIG. 18B, in block 1802, the process determines whether the cell is in a CELL_FACH state or a CELL_DCH state. If the process determines that the UE state is the CELL_FACH state, then the process branches to block 1804. In block 1804, the process determines whether the UE is a pre-release-8 UE. If the UE is a pre-release-8 UE, the process branches to block 1806. In block 1806, the process determines whether the PRACH preamble or the message part is detected. If the PRACH preamble or message part is not detected, the process returns to the start. If the PRACH preamble or message part is detected, as shown at \textcircled{1} in FIG. 14 or at \textcircled{1} in FIG. 15; respectively, then the process branches to block 1808. In block 1808, the process determines the offset from the AICH, which carries the macrocell's ACK/NAK response to preambles, as shown at \textcircled{2} in FIG. 14 for the PRACH preamble and at \textcircled{2} in FIG. 15 for the message part. In block 1810, the process determines the P-CCPCH slot boundary, utilizing the relationship between the start of the AICH access slot #0 and the P-CCPCH slots, as shown at \textcircled{3} in FIG. 14 for the PRACH preamble and at \textcircled{3} in FIG. 15 for the message part.

As shown in FIG. 18B, in block 1802, if the UE state is determined to be the CELL_FACH state, the process branches to block 1804. In block 1804, if the UE is determined not to be a pre-release-8 UE, the process branches to block 1812. In block 1812, the process determines whether the PRACH preamble, message part, or UL DPCCH are detected. If the PRACH preamble, message part, or UL DPCCH are not detected, the process returns to the start. If the PRACH preamble, message part, or UL DPCCH are detected, the process branches to block 1814. In block 1814, the process determines whether the PRACH preamble or message part are detected. If the PRACH preamble or message part are detected, the process branches to block 1818. In block 1818, the process determines the offset from AICH, which carries the macrocell's ACK/NAK response to preambles, as shown at \textcircled{2} in FIG. 14 for the PRACH preamble and at \textcircled{2} in FIG. 15 for the message part. In block 1820, the process determines the P-CCPCH slot boundary, utilizing the relationship between the start of the AICH access slot #0 and the P-CCPCH slots, as shown at \textcircled{3} in FIG. 14 for the PRACH preamble and at \textcircled{3} in FIG. 15 for the message part.

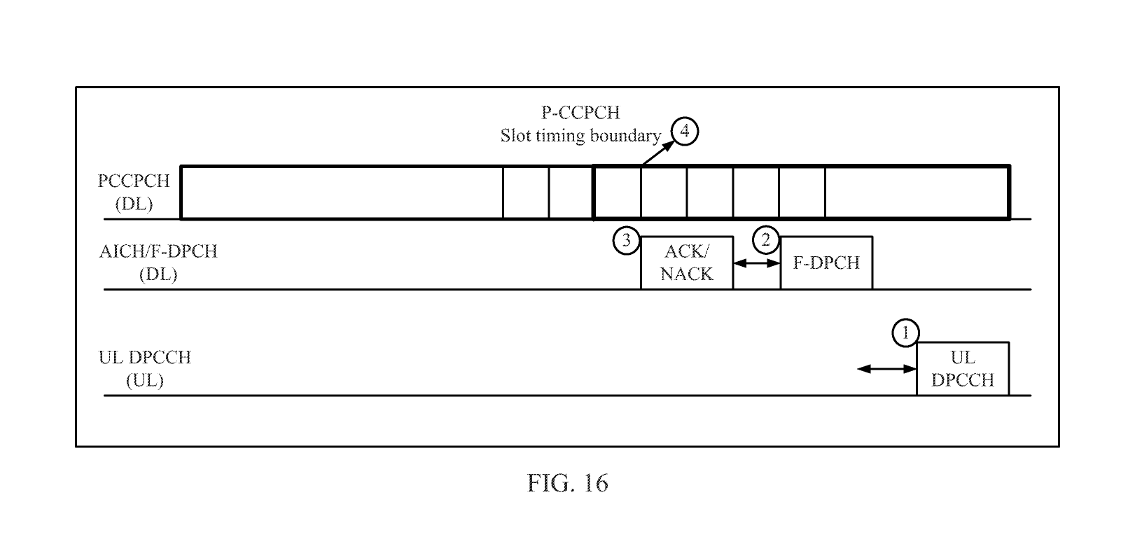

FIG. 16 illustrates the determination of the slot timing of the P-CCPCH using the UL DPCCH in the CELL_FACH state. As shown in FIG. 18B, in block 1802, if the UE state is determined to be the CELL_FACH state, the process branches to block 1804. In block 1804, if the UE is determined not to be a pre-release-8 UE, the process branches to block 1812. In block 1812, the process determines whether the PRACH preamble, message part, or UL DPCCH are detected. If the PRACH preamble, message part, or UL DPCCH are not detected, the process returns to the start. If the PRACH preamble, message part, or UL DPCCH are detected, the process branches to block 1814. In block 1814, the process determines whether the PRACH preamble or message part are detected. If the PRACH preamble and message part are not detected, the process branches to block 1816. In block 1816, the process determines the offset from F-DPCH, utilizing the relationship between UL-DPCCH and the F-DPCH, as shown at \textcircled{2} in FIG. 16. In block 1818, the process determines the offset from AICH, which carries the macrocell's ACK/NAK response to preambles, as shown at \textcircled{3} in FIG. 16. In block 1820, the process determines the P-CCPCH slot boundary, utilizing the relationship between the start of the AICH access slot #0 and the P-CCPCH slots, as shown at \textcircled{4} in FIG. 16.

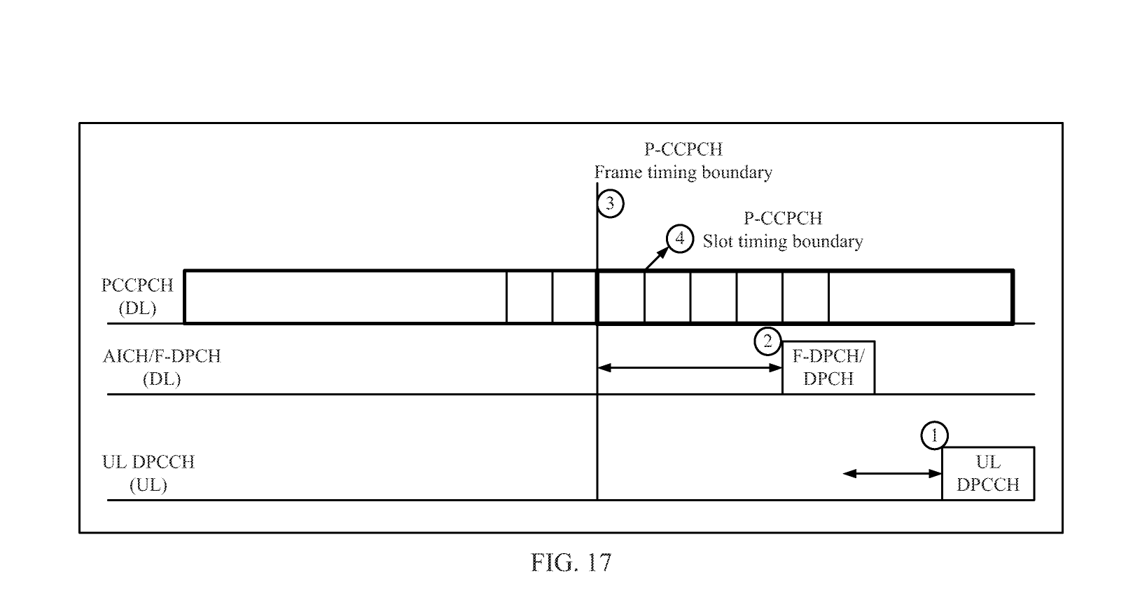

FIG. 17 illustrates the determination of the slot and frame timing of the P-CCPCH using the UL DPCCH in the CELL_DCH state. As shown in FIG. 18, in block 1802, if the UE state is determined to be the CELL_DCH state, the process branches to block 1822. In block 1822, the process determines whether the UL DPCCH is detected, as shown at \textcircled{1}. If UL DPCCH is not detected, the process returns to the start. If the UL DPCCH is detected on the downlink, then in block 1824, as shown at \textcircled{2} in FIG. 17, the process determines the offset of the DPCH 1310 or the F-DPCH 1320 (see FIGS. 13A and 13B). In block 1826, the process determines the P-CCPCH frame boundary, as shown at \textcircled{3} in FIG. 17. In block 1828, the process determines the P-CCPCH slot boundary, as shown at \textcircled{4} in FIG. 17.

Referring to FIG. 1 and FIG. 4, in one configuration, the apparatus 100 for wireless communication may include means for establishing a communication link with a macrocell, and means for transmitting first aiding information corresponding to the macrocell to a femtocell while maintaining the communication link with the macrocell. In a further configuration, the apparatus 100 may include means for gathering second aiding information corresponding to at least one neighboring macrocell, and means for transmitting the second aiding information corresponding to the at least one neighboring macrocell to the femtocell. For example, the means for transmitting the first aiding information may include means for transmitting over a band other than a band corresponding to the communication link with the macrocell. In a further configuration, the apparatus 100 may include means for transmitting interference information to the femtocell, the interference information corresponding to interference in one or more channels available to the femtocell. In a further configuration, the apparatus 100 may include means for receiving at a femtocell first aiding information from a first UE, the first aiding information corresponding to at least one cell of the plurality of cells, and means for adjusting a reference timing and/or frequency of the femtocell in response to the first aiding information. For example, the means for receiving the first aiding information from the first UE may be adapted to receive the first aiding information while the first UE is camped on the at least one cell of the plurality of cells. In another configuration, the apparatus 100 may include means for receiving second aiding information corresponding to at least a second cell of the plurality of cells from a second UE, and means for determining composite aiding information based on the first aiding information and the second aiding information.

The aforementioned means may be the processing system 114 configured to perform the functions recited by the aforementioned means. As described above, the processing system 114 may include the WWAN Processor 430, the WPAN Processor 450, the controller 460, and/or the I/O 470. As such, in one configuration, the aforementioned means may be the WWAN Processor 430, the WPAN Processor 450, the controller 460, and/or the I/O 470 configured to perform the functions recited by the aforementioned means.

Referring again to FIG. 1 and FIG. 4, in one configuration, the apparatus 100 for wireless communication may include means for sniffing an uplink transmission from a first UE camped on a neighboring cell, and means for determining aiding information corresponding to the neighboring cell based on the uplink transmission from the first UE. In a further configuration the apparatus 100 may include means for receiving a system information block transmitted from a neighboring cell. For example, the means for receiving the system information block may include means for receiving a wireless transmission from the neighboring cell by utilizing a network listen component of a femtocell. In a further configuration the apparatus 100 may include means for utilizing the system information block to extract signature information, a spreading code, and a scrambling code corresponding to the first UE. In a further configuration, the means for sniffing the uplink transmission from the first UE may include means for utilizing the signature information, spreading code, and scrambling code corresponding to the first UE to receive the uplink transmission from the first UE. In a further configuration, the apparatus 100 may include means for determining at least one of timing information or frequency information from the first UE based on the sniffed uplink transmission from the first UE. In a further configuration, the apparatus 100 may include means for adjusting at least one of timing or frequency in accordance with the at least one of timing information or frequency information to synchronize the respective timing or frequency with the neighboring cell. In a further configuration, the apparatus 100 may include means for receiving information about a first UE from a network node. For example, the means for receiving the information about the first UE may include means for receiving at least one of a radio bearer configuration message, a radio bearer reconfiguration message, or a radio bearer setup message from the network node. Further, the means for receiving the information about the first UE may include a backhaul connection with the network node. In a further configuration, the means for sniffing the uplink transmission from the first UE may include means for determining parameters of the uplink transmission from the first UE in accordance with the information about the first UE received from the network node, and means for utilizing the determined parameters of the uplink transmission to recognize the uplink transmission from the first UE. In a further configuration, the apparatus 100 may include means for determining at least one of timing information or frequency information from the first UE based on the sniffed uplink transmission from the first UE. In still a further configuration, the apparatus 100 may include means for adjusting at least one of timing or frequency in accordance with the at least one of timing information or frequency information to synchronize the respective timing or frequency with the neighboring cell.

The aforementioned means may be the processing system 114 configured to perform the functions recited by the aforementioned means. As described supra, the processing system 114 may include the receive processor 372, the WWAN processor 312, the WPAN processor 314, the I/O 373, the backhaul I/O 316, and/or the controller 315. As such, in one configuration, the aforementioned means may be the receive processor 372, the WWAN processor 312, the WPAN processor 314, the I/O 373, the backhaul I/O 316, and/or the controller 315 configured to perform the functions recited by the aforementioned means.

While the specification describes particular examples of the present invention, those of ordinary skill can devise variations of the present invention without departing from the inventive concept. For example, while certain teachings herein may refer to circuit-switched network elements they are equally applicable to packet-switched domain network elements.

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A method of wireless communication, comprising:
establishing a communication link with a macrocell; and
transmitting first aiding information corresponding to the macrocell to a femtocell while maintaining the communication link with the macrocell.

2. The method of claim 1, wherein the first aiding information comprises timing and/or frequency synchronization information.

3. The method of claim 1, further comprising creating a neighbor list for listing neighboring cells,
wherein the neighbor list includes the femtocell.

4. The method of claim 1, further comprising:
gathering second aiding information corresponding to at least one neighboring macrocell; and
transmitting the second aiding information corresponding to the at least one neighboring macrocell to the femtocell.

5. The method of claim 1, wherein the transmitting of the first aiding information comprises transmitting over a band other than a band corresponding to the communication link with the macrocell.

6. The method of claim 1, further comprising transmitting interference information to the femtocell, the interference information corresponding to interference in one or more channels available to the femtocell.

7. An apparatus for wireless communication, comprising:
at least one processor; and
a memory coupled to the at least one processor,
wherein the at least one processor is configured to:
establish a communication link with a macrocell; and
transmit first aiding information corresponding to the macrocell to a femtocell while maintaining the communication link with the macrocell.

8. The apparatus of claim 7, wherein the first aiding information comprises timing and/or frequency synchronization information.

9. The apparatus of claim 7, wherein the at least one processor is further configured to generate a neighbor list for listing neighboring cells,
wherein the neighbor list includes the femtocell.

10. The apparatus of claim 7, wherein the at least one processor is further configured to:
gather second aiding information corresponding to at least one neighboring macrocell; and
transmit the second aiding information corresponding to the at least one neighboring macrocell to the femtocell.

11. The apparatus of claim 7, wherein the transmitting of the first aiding information comprises transmitting over a band other than a band corresponding to the communication link with the macrocell.

12. The apparatus of claim 7, wherein the at least one processor is further configured to transmit interference information to the femtocell, the interference information corresponding to interference in one or more channels available to the femtocell.

13. An apparatus for wireless communication, comprising:
means for establishing a communication link with a macrocell; and
means for transmitting first aiding information corresponding to the macrocell to a femtocell while maintaining the communication link with the macrocell.

14. A computer program product for use in a wireless communication network comprising a plurality of cells, comprising:
a computer-readable medium comprising code for:
establishing a communication link with a macrocell; and
transmitting first aiding information corresponding to the macrocell to a femtocell while maintaining the communication link with the macrocell.

15. A method of wireless communication in a network comprising a plurality of cells, the method comprising:
receiving at a femtocell first aiding information from a first UE, the first aiding information corresponding to at least one cell of the plurality of cells; and
adjusting a reference timing and/or frequency of the femtocell in response to the first aiding information.

16. The method of claim 15, wherein the receiving of the first aiding information from the first UE occurs while the first UE is camped on the at least one cell of the plurality of cells.

17. The method of claim 15, wherein the receiving of the first aiding information comprises receiving the first aiding information over a band other than a band corresponding to a communication link utilized by the UE to communicate with the at least one cell of the plurality of cells.

18. The method of claim 15, further comprising:
receiving second aiding information corresponding to at least a second cell of the plurality of cells from a second UE; and
determining composite aiding information based on the first aiding information and the second aiding information.

19. The method of claim 18, wherein the first aiding information and the second aiding information comprise timing and/or frequency synchronization information corresponding to the at least one cell of the plurality of cells and the at least the second cell of the plurality of cells, respectively.

20. The method of claim 19, wherein the composite aiding information comprises an average corresponding to the first aiding information and the second aiding information.

21. The method of claim 18, wherein the second cell is the same cell as the at least one cell.

22. An apparatus for wireless communication in a network comprising a plurality of cells, the method comprising:
at least one processor; and
a memory coupled to the at least one processor,
wherein the at least one processor is configured to:
receive at a femtocell first aiding information from a first UE, the first aiding information corresponding to at least one cell of the plurality of cells; and
adjust a reference timing and/or frequency of the femtocell in response to the first aiding information.

23. The apparatus of claim 22, wherein the receiving of the first aiding information from the first UE occurs while the first UE is camped on the at least one cell of the plurality of cells.

24. The apparatus of claim 22, wherein the receiving of the first aiding information comprises receiving the first aiding information over a band other than a band corresponding to a communication link utilized by the UE to communicate with the at least one cell of the plurality of cells.

25. The apparatus of claim 22, wherein the at least one processor is further configured to:
receive second aiding information corresponding to at least a second cell of the plurality of cells from a second UE; and
determine composite aiding information based on the first aiding information and the second aiding information.

26. The apparatus of claim 25, wherein the first aiding information and the second aiding information comprise timing and/or frequency synchronization information corresponding to the at least one cell of the plurality of cells and the at least the second cell of the plurality of cells, respectively.

27. The apparatus of claim 26, wherein the composite aiding information comprises an average corresponding to the first aiding information and the second aiding information.

28. The apparatus of claim 25, wherein the second cell is the same cell as the at least one cell.

29. An apparatus for wireless communication in a network comprising a plurality of cells, the method comprising:
means for receiving at a femtocell first aiding information from a first UE, the first aiding information corresponding to at least one cell of the plurality of cells; and
means for adjusting a reference timing and/or frequency of the femtocell in response to the first aiding information.

30. A computer program product for use in a wireless communication network comprising a plurality of cells, comprising:
a computer-readable medium comprising code for:
receiving at a femtocell first aiding information from a first UE, the first aiding information corresponding to at least one cell of the plurality of cells; and
adjusting a reference timing and/or frequency of the femtocell in response to the first aiding information.

31. A method of wireless communication, comprising:
sniffing an uplink transmission from a first UE connected to a neighboring cell; and
determining aiding information corresponding to the neighboring cell based on the uplink transmission from the first UE.

32. The method of claim 31, wherein the aiding information comprises timing and/or frequency synchronization information.

33. The method of claim 31, further comprising receiving a detection parameter from a network node.

34. The method of claim 33, wherein the sniffing of the uplink transmission from the first UE comprises utilizing the detection parameter to receive the uplink transmission from the first UE.

35. The method of claim 34, further comprising determining at least one of timing information or frequency information from the first UE based on the sniffed uplink transmission from the first UE.

36. The method of claim 35, further comprising adjusting at least one of timing or frequency in accordance with the at least one of timing information or frequency information to synchronize the respective timing or frequency with the neighboring cell.

37. The method of claim 31, wherein the receiving of the detection parameter is accomplished through a backhaul connection with the network node.

38. The method of claim 37, wherein the network node comprises a radio network controller.

39. The method of claim 37, wherein the network node comprises a neighboring base station.

40. The method of claim 31, wherein the sniffing of the uplink transmission from the first UE comprises:
determining parameters of the uplink transmission from the first UE in accordance with the detection parameter received from the network node; and
utilizing the determined parameters of the uplink transmission to recognize the uplink transmission from the first UE.

41. The method of claim 40, wherein the parameters of the uplink transmission from the first UE comprise a spreading code, a scrambling code, and timing offset information corresponding to the first UE.

42. The method of claim 31, further comprising determining at least one of timing information or frequency information from the first UE based on the sniffed uplink transmission from the first UE.

43. The method of claim 42, further comprising adjusting at least one of timing or frequency in accordance with the at least one of timing information or frequency information to synchronize the respective timing or frequency with the neighboring cell.

44. An apparatus for wireless communication, comprising:
at least one processor; and
a memory coupled to the at least one processor,
wherein the at least one processor is configured to:
sniff an uplink transmission from a first UE connected to a neighboring cell; and
determine aiding information corresponding to the neighboring cell based on the uplink transmission from the first UE.

45. The apparatus of claim 44, wherein the aiding information comprises timing and/or frequency synchronization information.

46. The apparatus of claim 44, wherein the at least one processor is further configured to receive a detection parameter from a network node.

47. The apparatus of claim 46, wherein the sniffing of the uplink transmission from the first UE comprises utilizing the detection parameter to receive the uplink transmission from the first UE.

48. The apparatus of claim 47, wherein the at least one processor is further configured to determine at least one of timing information or frequency information from the first UE based on the sniffed uplink transmission from the first UE.

49. The apparatus of claim 48, wherein the at least one processor is further configured to adjust at least one of timing or frequency in accordance with the at least one of timing information or frequency information to synchronize the respective timing or frequency with the neighboring cell.

50. The apparatus of claim 44, wherein the receiving of the detection parameter is accomplished through a backhaul connection with the network node.

51. The apparatus of claim 50, wherein the network node comprises a radio network controller.

52. The apparatus of claim 50, wherein the network node comprises a neighboring base station.

53. The apparatus of claim 44, wherein the sniffing of the uplink transmission from the first UE comprises:
determining parameters of the uplink transmission from the first UE in accordance with the detection parameter received from the network node; and
utilizing the determined parameters of the uplink transmission to recognize the uplink transmission from the first UE.

54. The apparatus of claim 53, wherein the parameters of the uplink transmission from the first UE comprise a spreading code, a scrambling code, and timing offset information corresponding to the first UE.

55. The apparatus of claim 44, wherein the at least one processor is further configured to determine at least one of timing information or frequency information from the first UE based on the sniffed uplink transmission from the first UE.

56. The apparatus of claim 55, wherein the at least one processor is further configured to adjust at least one of timing or frequency in accordance with the at least one of timing information or frequency information to synchronize the respective timing or frequency with the neighboring cell.

57. An apparatus for wireless communication, comprising:
means for sniffing an uplink transmission from a first UE camped on a neighboring cell; and
means for determining aiding information corresponding to the neighboring cell based on the uplink transmission from the first UE.

58. A computer program product for use in a wireless communication network comprising a plurality of cells, comprising:
a computer-readable medium comprising code for:
sniffing an uplink transmission from a first UE camped on a neighboring cell; and
determining aiding information corresponding to the neighboring cell based on the uplink transmission from the first UE.
